(19) United States
(12) Patent Application Publication
(10) Pub. No.: US 2026/0308881 A1
(43) Pub. Date: Oct. 8, 2026

(54) HYDRAULIC CONTROL SYSTEM FOR CONSTRUCTION MACHINES, AND CONTROL METHOD THEREOF

(71) Applicant: HD CONSTRUCTION EQUIMENT CO., LTD., Seongnam-si (KR)

(72) Inventors: Sunghoon LEE, Seoul (KR); Yoonkyu YOO, Incheon (KR); Wonsun SOHN, Seoul (KR); Wooyong JUNG, Seoul (KR)

(21) Appl. No.: 18/996,803

(22) PCT Filed: Aug. 9, 2023
(86) PCT No.: PCT/KR2023/011715

§ 371 Date: Jan. 17, 2025

(30) Foreign Application Priority Data
Aug. 9, 2022 (KR) 10-2022-0099203

(51) Int. Cl. E02F 9/22

(52) U.S. Cl. CPC E02F 9/2246; E02F 9/226

(57) ABSTRACT

The present invention relates to a hydraulic control system for construction machines and a control method thereof, the system comprising: a main pump driven by an engine provided in a construction machine; a fan pump supplying hydraulic oil to a cooling fan to cool the engine; and a controller (EPOS) provided to control the operation of the engine, the main pump, and the fan pump.

### TECHNICAL FIELD

The present disclosure relates to a hydraulic control system for a construction machine, and more specifically, to a hydraulic control system for a construction machine that can quickly restore engine speed after deactivating the auto idle function of the construction machine.

### BACKGROUND ART

A construction machine has a function that reduces engine speed to a set speed to reduce fuel efficiency and noise when it remains idle without performing any work for a set period of time. This is called an “Auto idle” function.

When the auto idle function is deactivated, the engine speed should rise to an initial set level to start working again. At this time, recovery time for increasing the engine speed to the initial set level is determined depending on the dynamic characteristics of the engine and the load conditions of equipment (main pump, fan pump).

If the recovery time for increasing the engine speed to the initial set level is slow, an operator may feel that the engine has no power, so it is important to recover the engine speed within a short period of time.

In a conventional construction machine, since there is no additional control function provided during the process of restoring the engine speed to the initial set level after deactivating the auto idle function, the recovery time of the engine speed is determined depending on the characteristics of the engine and the pump.

Accordingly, when the dynamic characteristics of the engine are not good, the auto idle speed is set high to accelerate the recovery time of the engine speed. However, in this case, there arises a problem where fuel efficiency and noise reduction effects during the operation of the auto idle function are reduced.

### DETAILED DESCRIPTION OF INVENTION

### Technical Problems

The present disclosure provides a hydraulic control system for a construction machine and a control method thereof, which can control the operation of a main pump and a fan pump so as to reduce the load of the main pump and the fan pump after the auto idle function of the construction machine is deactivated, thereby allowing an engine to quickly recover to an initial set speed.

### Technical Solution

According to an embodiment of the present disclosure, a hydraulic control system comprises a main pump driven by an engine provided in the construction machine; a fan pump supplying hydraulic oil to a cooling fan to cool the engine; and a controller (EPOS) provided to control the operation of the engine, the main pump, and the fan pump. If an auto idle function of the construction machine is deactivated, the controller restricts the operation of the fan pump to reduce the load of the fan pump for a set time so that the rotation speed of the engine is restored from an auto idle rotation speed to a set rotation speed setting value.

Further, the fan pump is driven by the engine.

Further, the controller does not restrict the operation of the fan pump after the set time.

The hydraulic control system further comprises a fan pump control valve provided to limit the load of the fan pump, and the controller controls a control value of the fan pump control valve to a set minimum control value so that the load of the fan pump is equal to or less than a set reference for a set time when the auto idle function is deactivated.

Further, if the auto idle function of the construction machine is deactivated, the controller restricts an operation to reduce the load of the main pump for a set time so that the rotation speed of the engine is restored from the auto idle rotation speed to a set rotation speed setting value

The hydraulic control system further comprises a main pump control valve configured to limit the load of the main pump; and a pressure sensor configured to measure the discharge flow pressure of the main pump, and the controller stores a table of maximum torque values according to the rotation speed of the engine, and the controller derives the torque value of the main pump from the discharge flow of the main pump and the discharge flow pressure measurement value of the main pump, and adjusts the control value of the main pump control valve to a set control value so that the torque value of the main pump is reduced below a minimum torque value stored in the table for a set time when the auto idle function is deactivated.

The hydraulic control system further comprises a gauge panel configured to transmit the ON/OFF status of the auto idle function and the set rotation speed setting value to the controller; and a joystick pilot pressure sensor configured to detect an operator's joystick operation value and transmit the value to the controller, and the controller activates or deactivates the auto idle function depending on the ON/OFF status of the auto idle function and the work or driving signal of the construction machine.

The hydraulic control system further comprises a joystick pilot pressure sensor configured to detect an operator's joystick operation value and transmit the value to the controller, and the controller restricts the operation of the fan pump when the joystick operation value is equal to or greater than a certain reference.

The controller derives the torque value of the main pump from the discharge flow of the main pump and the discharge flow pressure measurement value of the main pump, and restricts the operation of the fan pump when the torque value of the main pump is equal to greater than a certain value.

According to another embodiment of the present disclosure, a method of controlling a hydraulic control system comprises executing an auto idle function of the construction machine; inputting an OFF signal of the auto idle function during the execution of the auto idle function; and restricting the operation of the fan pump to reduce a load of the fan pump for a set time, thereby restoring a rotation speed of an engine to a set rotation speed setting value, when the auto idle function is deactivated.

Further, the restoring the rotation speed of the engine to the set rotation speed setting value restricts the operation of the main pump so that the load of the main pump is reduced for a set time, when the auto idle function is deactivated.

Further, in the restoring the rotation speed of the engine to the set rotation speed setting value, if a joystick operation value is equal to or greater than a certain reference, the operation of the fan pump is restricted.

Further, the restoring the rotation speed of the engine to the set rotation speed setting value comprises adjusting by the controller the control value of a fan pump control valve connected to the fan pump so that the load of the fan pump is equal to or less than a set reference for a set time.

The restoring the rotation speed of the engine to the set rotation speed setting value further comprises deriving by the controller a discharge flow of the main pump; deriving by the controller the torque value of the main pump using the discharge flow of the main pump and a pressure measurement value of the discharge flow of the main pump; and restricting the operation of the fan pump when the torque value of the main pump is equal to or greater than a certain value.

The restoring the rotation speed of the engine to the set rotation speed setting value further comprises deriving by the controller a discharge flow of the main pump; deriving by the controller the torque value of the main pump using the discharge flow of the main pump and a pressure measurement value of the discharge flow of the main pump; comparing by the controller a torque value of the main pump with a pre-stored table of maximum torque values according to the rotation speed of the engine; and adjusting by the controller a control value of a main pump control valve connected to the main pump to a set control value so that the torque value of the main pump is reduced below a minimum torque value stored in the table for a set time.

Further, before restoring the rotation speed of the engine to the set rotation speed setting value, if a driving or work signal is not input from a joystick pilot pressure sensor for a set time after the OFF signal of the auto idle function is input, the auto idle function is maintained.

The method further comprises, before executing the auto idle function of the construction machine, inputting an ON signal of the auto idle function during the work or driving of the construction machine; and checking whether a work or driving signal is input from the joystick pilot pressure sensor for a set time.

Further, in the restoring the rotation speed of the engine to the set rotation speed setting value, the operation of the main pump and the fan pump is not restricted after the set time.

Specific details of other embodiments are included in the detailed description and drawings.

### Effect of Invention

A hydraulic control system for a construction machine according to the present disclosure has the following effects.

First, by adjusting the output value of a valve that limits the load of a fan pump and a main pump for a set time after an auto idle function is deactivated, the load of the fan pump and the main pump can be reduced, and an engine speed can quickly recover to a set speed setting value.

Second, since an engine idle speed does not need to be set high when an auto idle function is in operation, fuel efficiency and noise reduction can be achieved.

### BRIEF DESCRIPTION OF THE DRAWING

FIG. 1 is a schematic view illustrating the configuration of a hydraulic control system for a construction machine according to an embodiment of the present disclosure.

FIGS. 2 and 3 are flow charts illustrating the control process of a hydraulic control system for a construction machine according to an embodiment of the present disclosure.

FIG. 4 is a graph illustrating a process of changing engine speed using a control method of a hydraulic control system for a construction machine according to an embodiment of the present disclosure.

### BEST MODE FOR CARRYING OUT THE INVENTION

Hereinafter, embodiments of the present disclosure will be described in detail with reference to the accompanying drawings such that those skilled in the art can easily practice the present disclosure. However, the present disclosure may be implemented in various ways without being limited to particular embodiments described herein.

It is to be noted that the drawings are schematic and not drawn to scale. The dimensions and proportions of components shown in the drawings may be exaggerated or reduced for the clarity and convenience of description, and any dimensions are merely for illustrative purposes and not restrictive. . The same reference numerals are used throughout the drawings to designate the same or similar components.

The ideal embodiment of the present disclosure will be described in detail. As a result, various modifications of the diagram are expected. Therefore, the embodiment is not limited to a specific form illustrated, and also includes modifications of the form by manufacturing, for example.

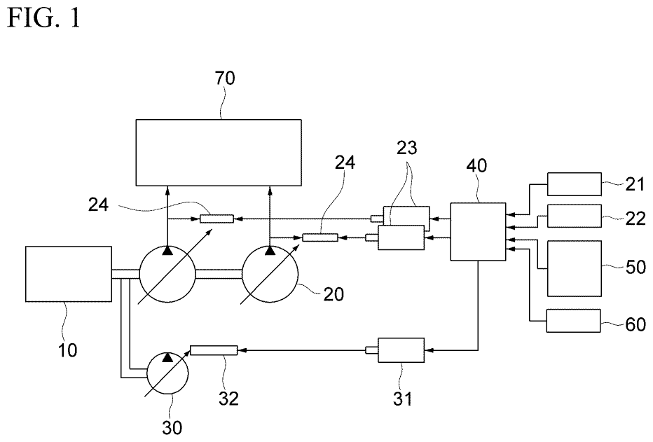

FIG. 1 illustrates the configuration of a hydraulic control system for a construction machine according to an embodiment of the present disclosure. First, the configuration of the hydraulic control system for the construction machine will be described below with reference to FIG. 1.

The hydraulic control system for the construction machine according to an embodiment of the present disclosure includes an engine 10, a main pump 20, a fan pump 30, a swash plate angle sensor 21, a pressure sensor 22, and a controller 40.

The engine 10 receives fuel and provides power to drive the construction machine. The power provided by the engine 10 is transmitted to the main pump 20.

The main pump 20 supplies hydraulic oil to an attachment (not shown), such as a boom or a bucket, provided on the construction machine. One or more main pumps 20 may be provided. The number of the main pumps 20 varies depending on the attachment (not shown) provided on the construction machine.

The hydraulic pressure discharged from the main pump 20 is transmitted to the main control valve 70, and is transmitted from the main control valve 70 to each attachment.

The fan pump 30 is driven by the engine 10. The fan pump 30 supplies hydraulic oil to operate a cooling fan (not shown) that is provided to cool the engine 10.

Meanwhile, the present disclosure is not limited to an embodiment where the fan pump 30 is driven by the engine 10. The fan pump 30 may not be driven by the engine 10 and may be selectively applied.

The swash plate angle sensor 21 is provided in the main pump 20. If a plurality of main pumps 20 are provided, the swash plate angle sensor 21 is provided in each of the main pumps 20, so that a plurality of swash plate angle sensors 21 are also provided. The swash plate angle sensor 21 measures the swash plate angle of the main pump 20. A swash plate angle measurement value measured by the swash plate angle sensor 21 is transmitted to the controller 40, and is used to derive the discharge flow of the main pump 20.

The pressure sensor 22 is provided in the main pump 20. Specifically, the pressure sensor is mounted on a discharge end where the flow is discharged from the main pump 20. The pressure sensor 22 measures pressure formed by the flow discharged from the main pump 20. The pressure measurement value measured by the pressure sensor 22 is transmitted to the controller 40.

The controller 40 is provided to control the operation of the engine 10, the main pump 20, and the fan pump 30.

If the auto idle function of the construction machine is deactivated, the controller 40 restricts the operation of the main pump 20 and the fan pump 30 to reduce the load of at least one of the main pump 20 and the fan pump 30 for a set time so that the rotation speed of the engine 10 is restored from the auto idle rotation speed to a set rotation speed setting value. After the set time, the operation of the main pump 20 and the fan pump 30 is not limited. A process in which the controller 40 restricts the main pump 20 and the fan pump 30 will be described below in detail.

The hydraulic control system for the construction machine further includes a gauge panel 50, a joystick pilot pressure sensor 60, a main pump control valve 23, and a fan pump control valve 31.

The gauge panel 50 is provided in a cabin (not shown) of the construction machine. When an operator selects whether to turn on or off the auto idle function of the construction machine, the selection may be transmitted through the gauge panel 50 to the controller 40, and the set rotation speed setting value of the engine 10 may be input and transmitted to the controller 40.

The controller 40 activates or deactivates the auto idle function depending on whether the auto idle function is on or off and the work or driving signal of the construction machine.

The controller 40 uses information on whether the auto idle function is on or off and the set rotation speed setting value of the engine 10, which is received from the gauge panel 50, to control the main pump 20.

The joystick pilot pressure sensor 60 is provided in a joystick pilot line (not shown). The joystick pilot pressure sensor 60 detects an operation value when the operator operates a joystick (not shown) and then transmits the operation value to the controller 40. Specifically, when the operator operates the joystick (not shown) into any one of a work state, a driving state, a neutral state, and a parking state, the operation value at that time is detected and transmitted to the controller 40.

The controller 40 may determine whether the auto idle function is maintained or the auto idle function is deactivated based on the joystick operation value transmitted from the joystick pilot pressure sensor 60.

For example, the controller 40 may not immediately execute the auto idle function when it receives an ON signal of the auto idle function from the gauge panel 50. When the controller 40 checks whether no work or driving signal is input from the joystick pilot pressure sensor 60 for a set time after receiving the ON signal of the auto idle function from the gauge panel 50, the controller activates the auto idle function to control the rotation speed of the engine 10 to operate at the auto idle rotation speed.

Meanwhile, when no work or driving signal is input from the joystick pilot pressure sensor 60 for a set time after receiving an OFF signal of the auto idle function from the gauge panel 50, the controller 40 maintains the auto idle function.

On the other hand, when the controller 40 receives the OFF signal of the auto idle function from the gauge panel 50 and then receives the work or driving signal from the joystick pilot pressure sensor 60 for a set time, the controller deactivates the auto idle function.

In this way, the controller 40 receives signals from the gauge panel 50 and the joystick pilot pressure sensor 60 and controls the auto idle function of the engine 10.

Further, when the OFF signal of the auto idle function is input to deactivate the auto idle function, the controller 40 restricts the operation of the fan pump 30 if the operation value of the joystick is equal to or greater than a certain reference value in response to a signal that is input from the joystick pilot pressure sensor 60.

On the other hand, the controller 40 determines that the construction machine is in full operation when the torque value of the main pump 20 is high. Thus, the controller 40 restricts the operation of the fan pump 30 when the torque value of the main pump 20 is equal to or greater than a certain value.

The main pump control valve 23 is provided between the controller 40 and the main pump 20. In this embodiment, the main pump control valve 23 is provided as an electronic proportional pressure reducing valve. The main pump control valve 23 limits the load of the main pump 20 in response to a signal that is input from the controller 40.

In this embodiment, after the auto idle function of the construction machine is deactivated, the main pump control valve 23 controls the operation of the main pump 20 to reduce the load of the main pump 20, allowing the rotation speed of the engine 10 to quickly recover to a set rotation speed setting value. The specific control process will be described later.

The fan pump control valve 31 is provided between the controller 40 and the fan pump 30. The fan pump control valve 31 controls the load of the fan pump 30 in response to the signal that is input from the controller 40.

In this embodiment, if the auto idle function of the construction machine is deactivated, the fan pump control valve 31 controls the operation of the fan pump 30 to reduce the load of the fan pump 20, allowing the rotation speed of the engine 10 to quickly recover to a set rotation speed setting value. The specific control process will be described later.

When the construction machine is under a heavy load, such as when a bucket is loaded with materials, it enters the auto idle state when work is stopped for a while. At this time, if the operation is resumed (full operation), the equipment moves slowly. As described above, when the load is reduced by limiting the operation of the fan pump 30 and the main pump 20, it helps to quickly recover the RPM of the engine 10, allowing the operator to proceed with work at a high speed even after the auto idle.

In this embodiment, the main pump control valve 23 and the fan pump control valve 31 are provided as electronic proportional pressure reducing valves (EPPR valve). Thus, the controller 40 applies the control values of the main pump control valve 23 and the fan pump control valve 31 as current values. Since the main pump control valve 23 and the fan pump control valve 31 are not limited to the electronic proportional pressure reducing valves, they may be changed in various ways depending on the environment.

Meanwhile, the hydraulic control system of the construction machine is provided with pump regulators 24 and 32. The pump regulators 24 and 32 are provided for each pump, i.e., the main pump 20 and the fan pump 30, respectively.

The pump regulators 24 and 32 set and adjust the pressure of the pumps. The pump regulators 24 and 32 adjust the swash plate angles of the main pump 20 and the fan pump 30 when the auto idle function is deactivated and the controller 40 applies set control values to the main pump control valve 23 and the fan pump control valve 31. Thus, the main pump 20 and the fan pump 30 are limited to reduce the load.

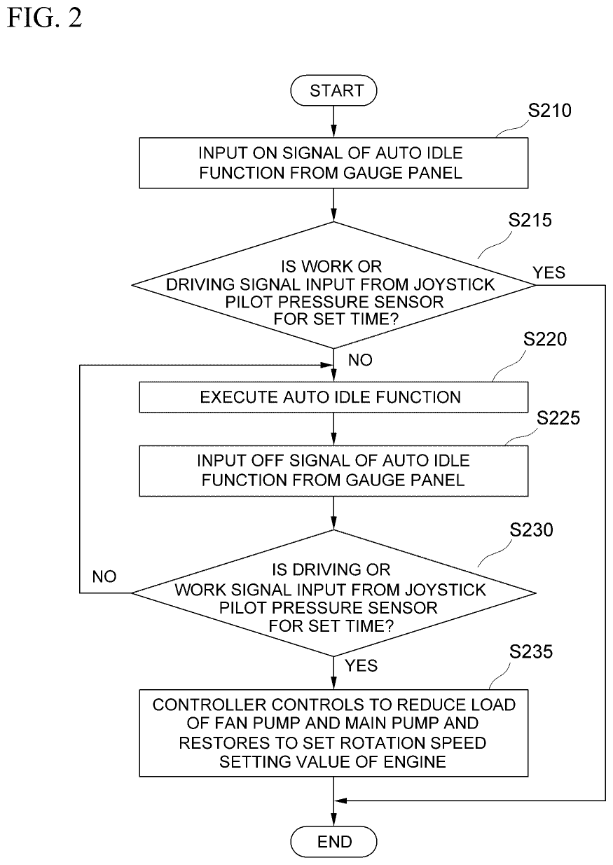

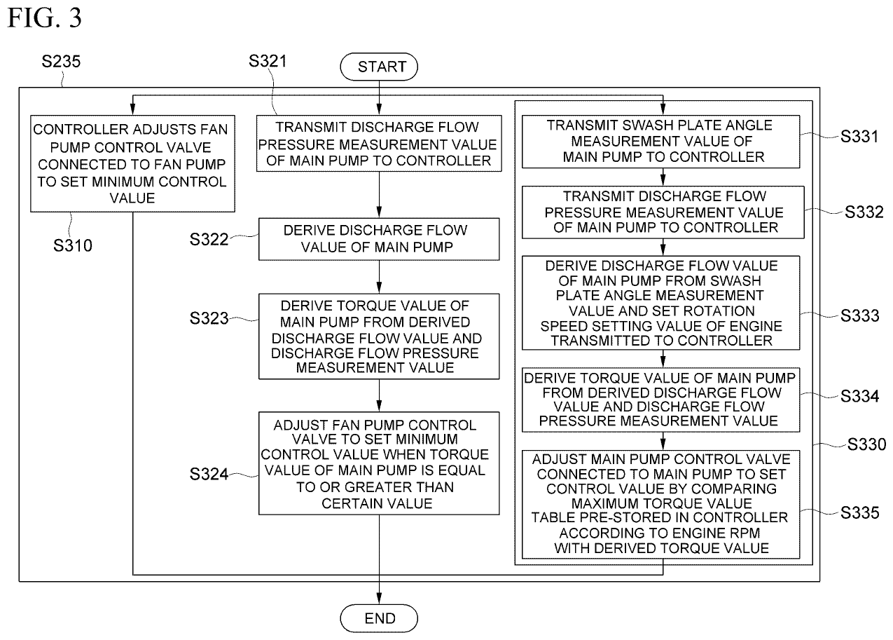

Hereinafter, the control process of the hydraulic control system for the construction machine according to an embodiment of the present disclosure will be described in detail with reference to FIGS. 2 and 3.

First, when the operator wants to temporarily stop working or driving the construction machine during working or driving, the auto idle function is executed. At this time, the ON signal of the auto idle function is input from the gauge panel 50 to the controller 40 (step S210).

When the ON signal of the auto idle function is input from the gauge panel 50 to the controller 40, the controller checks whether the work or driving signal is input from the joystick pilot pressure sensor 60 for a set time (step S215).

The step S215 is a step of checking whether the construction machine has not operated for a set time. Thus, if no work or driving signal is input for the set time in step S215, the auto idle function is executed (step S220). At this time, the rotation speed of the engine 10 is switched to the auto idle rotation speed.

On the other hand, if the work or driving signal is input for the set time in step S215, it is determined that the auto idle function should not be activated, so that the auto idle function is not executed.

During the execution of the auto idle function, it is checked whether the OFF signal of the auto idle function is input from the user (step S225) or the work or driving signal is input from the joystick pilot pressure sensor 60 (step S230).

The controller 40 deactivates the auto idle function of the construction machine when the OFF signal of the auto idle function is input or the work or driving signal is input from the joystick pilot pressure sensor 60.

Meanwhile, the controller 40 maintains the auto idle function of the construction machine if no work or driving signal is input from the joystick pilot pressure sensor 60 even if the OFF signal of the auto idle function is input.

When the auto idle function is deactivated, the rotation speed of the engine 10 should be restored to the set rotation speed setting value. At this time, the controller 40 limits the operation of the fan pump 30 and the main pump 20 to reduce the load of at least one of the fan pump 30 and the main pump 20 so that the rotation speed of the engine 10 may be quickly restored to the set rotation speed setting value (step S235).

In this embodiment, the load of both the fan pump 30 and the main pump 20 is limited.

The process of the step S235 will be described in more detail with reference to FIG. 3.

When the auto idle function is deactivated, the controller 40 restricts the operation of the fan pump 30 if the operation value of the joystick transmitted from the joystick pilot pressure sensor 60 reaches or exceeds a certain reference value. The operation limit of the fan pump 30 adjusts the control value of the fan pump control valve 31 to a set minimum control value so that the load of the fan pump 30 is equal to or less than a set reference value (step S310).

For example, the expression “the load of the fan pump 30 is equal to or less than the set reference value” means that the speed (RPM) of the fan pump 30 is equal to or less than a set reference speed. That is, when the set minimum current value is applied to the fan pump control valve 31 and the speed (RPM) of the fan pump 30 is reduced, the load is decreased.

Meanwhile, when the auto idle function is deactivated, the controller 40 may limit the operation of the fan pump 30 based on criteria other than the operation value of the joystick as described above.

When the controller 40 receives the discharge flow pressure measurement value of the main pump 20 (step S321) and derives the discharge flow value of the main pump 20 (step S322), the controller derives the torque value of the main pump 20 from the discharge flow pressure measurement value and the discharge flow value (step S323).

When the derived torque value of the main pump 20 is equal to or greater than a certain value, the controller 40 restricts the operation of the fan pump 30.

As described above, the operation of the fan pump 30 is limited by adjusting the control value of the fan pump control valve 31 to the set minimum control value. Here, when the torque value of the main pump 20 is high, the controller 40 determines that the construction machine is in full operation and restricts the operation of the fan pump 30.

Meanwhile, the controller 40 limits the operation of the main pump 20 so that the load of the main pump 20 is reduced when the auto idle function is deactivated (step S330). To this end, first, the controller 40 receives the swash plate angle measurement value of the main pump 20 from the swash plate angle sensor 21 (step S331). Further, the pressure measurement value of the flow discharged by the main pump 20 is transmitted from the pressure sensor 22 (step S332).

The controller 40 derives the discharge flow value of the main pump 20 from the swash plate angle measurement value and the set rotation speed setting value of the engine 10 transmitted by the gauge panel 50 (step S333). The controller 40 may store a setting calculation formula or table for deriving the discharge flow of the main pump 20. Therefore, the discharge flow value of the main pump 20 is derived by substituting the set rotation speed setting value and the swash plate angle measurement value into the setting calculation formula or table. The setting calculation formula or table is not specified because it may be set in various ways by the manufacturer (designer) of the construction machine.

The torque value of the main pump 20 is derived from the derived discharge flow value and the pressure measurement value of the discharge flow (step S334).

The controller 40 stores the table of the maximum torque values according to the rotation speed of the engine 10. The controller 40 compares the torque value derived in step S334 with the pre-stored table.

The controller 40 controls the main pump 20 so that the torque value of the main pump 20 does not exceed the smallest torque value among the maximum torque values stored in the table. Specifically, the control value of the main pump control valve 23 is adjusted to a set control value so that the load of the main pump 20 may be reduced below a set reference (step S335). The load of the main pump 20 is reduced below the set reference by applying a set current value to the main pump control valve 23 so that the speed (RPM) of the main pump 20 is reduced below the set reference, similarly to the fan pump 30. Thus, as the speed (RPM) of the main pump 20 decreases, the load of the main pump 20 decreases.

In this way, the controller 40 limits the operation of the main pump 20 and the fan pump 30 so that the load of the main pump 20 and the fan pump 30 is reduced as in step S235, thereby allowing the rotation speed of the engine 10 to quickly recover to the set rotation speed setting value.

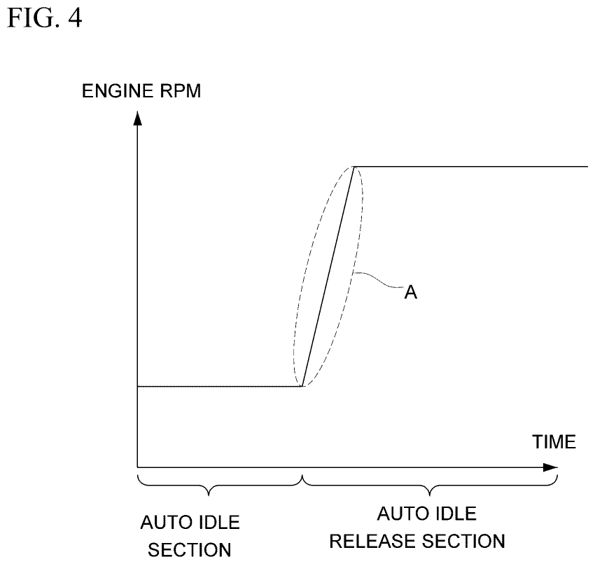

FIG. 4 is a graph showing the process in which the engine speed changes due to the operation restrictions of the fan pump 30 and the main pump 20 when the auto idle operation of the construction machine is released. Referring to FIG. 4, in a zone where the construction machine operates in an auto idle mode, the engine 10 rotates at the auto idle speed. When the construction machine resumes operation, the auto idle mode is released, and the operation of the fan pump and main pump is restricted, so that the engine speed quickly recovers as in area (A).

After the auto idle function is deactivated, the construction machine may quickly recover the set rotation speed setting value by limiting the operation of the main pump 20 and the fan pump 30 so that the load of the main pump 20 and the fan pump 30 is reduced by the controller 40 as described above. In addition, by limiting the load of the main pump 20 and the fan pump 30, it is not necessary to increase the auto idle rotation speed of the engine 10 when the auto idle function is executed. This allows the construction machine to maintain improved fuel efficiency and reduced noise levels.

Although the present disclosure has been described above with reference to preferred embodiments, it will be understood by those skilled in the art that various modifications and changes may be made to the present disclosure without departing from the idea and scope of the present disclosure as set forth in the following claims.

Therefore, the above-described embodiments should be understood as illustrative rather than restrictive in every aspect. The scope of the present disclosure is defined by the following claims, and all changes or modifications derived from the meanings, scope, and equivalent concepts of the claims should be interpreted as being included within the scope of the present disclosure.

What is claimed is:

1. A hydraulic control system for a construction machine, the system comprising:
a main pump driven by an engine provided in the construction machine;
a fan pump supplying hydraulic oil to a cooling fan to cool the engine; and
a controller (EPOS) provided to control the operation of the engine, the main pump, and the fan pump,
wherein if an auto idle function of the construction machine is deactivated, the controller restricts the operation of the fan pump to reduce the load of the fan pump for a set time so that the rotation speed of the engine is restored from an auto idle rotation speed to a set rotation speed setting value.

2. The hydraulic control system of claim 1, wherein the fan pump is driven by the engine.

3. The hydraulic control system of claim 1, wherein the controller does not restrict the operation of the fan pump after the set time.

4. The hydraulic control system of claim 1, further comprising:
a fan pump control valve provided to limit the load of the fan pump,
wherein the controller adjusts a control value of the fan pump control valve so that the load of the fan pump is equal to or less than a set reference for a set time when the auto idle function is deactivated.

5. The hydraulic control system of claim 1, wherein if the auto idle function of the construction machine is deactivated, the controller restricts an operation to reduce the load of the main pump for a set time so that the rotation speed of the engine is restored from the auto idle rotation speed to a set rotation speed setting value

6. The hydraulic control system of claim 5, further comprising:
a main pump control valve configured to limit the load of the main pump; and
a pressure sensor configured to measure the discharge flow pressure of the main pump,
wherein:
the controller stores a table of maximum torque values according to the rotation speed the engine, and
the controller derives the torque value of the main pump from the discharge flow of the main pump and the discharge flow pressure measurement value of the main pump, and adjusts the control value of the main pump control valve to a set control value so that the torque value of the main pump is reduced below a minimum torque value stored in the table for a set time when the auto idle function is deactivated.

7. The hydraulic control system of claim 1, further comprising:
a gauge panel configured to transmit the ON/OFF status of the auto idle function and the set rotation speed setting value to the controller; and
a joystick pilot pressure sensor configured to detect an operator's joystick operation value and transmit the value to the controller,
wherein the controller activates or deactivates the auto idle function depending on the ON/OFF status of the auto idle function and the work or driving signal of the construction machine.

8. The hydraulic control system of claim 1, further comprising:
a joystick pilot pressure sensor configured to detect an operator's joystick operation value and transmit the value to the controller,
wherein the controller restricts the operation of the fan pump when the joystick operation value is equal to or greater than a certain reference.

9. The hydraulic control system of claim 1, wherein the controller derives the torque value of the main pump from the discharge flow of the main pump and the discharge flow pressure measurement value of the main pump, and restricts the operation of the fan pump when the torque value of the main pump is equal to greater than a certain value.

10. A method of controlling a hydraulic control system for a construction machine, the method comprising:
executing an auto idle function of the construction machine;
inputting an OFF signal of the auto idle function during the execution of the auto idle function; and
restricting the operation of the fan pump to reduce a load of the fan pump for a set time, thereby restoring a rotation speed of an engine to a set rotation speed setting value, when the auto idle function is deactivated.

11. The method of claim 10, wherein the restoring the rotation speed of the engine to the set rotation speed setting value restricts the operation of the main pump so that the load of the main pump is reduced for a set time, when the auto idle function is deactivated.

12. The method of claim 10, wherein, in the restoring the rotation speed of the engine to the set rotation speed setting value, if a joystick operation value is equal to or greater than a certain reference, the operation of the fan pump is restricted.

13. The method of claim 12, wherein the restoring the rotation speed of the engine to the set rotation speed setting value comprises adjusting by the controller the control value of a fan pump control valve connected to the fan pump so that the load of the fan pump is equal to or less than a set reference for a set time.

14. The method of claim 10, wherein the restoring the rotation speed of the engine to the set rotation speed setting value further comprises:
deriving by the controller a discharge flow of the main pump;
deriving by the controller the torque value of the main pump using the discharge flow of the main pump and a pressure measurement value of the discharge flow of the main pump; and
restricting the operation of the fan pump when the torque value of the main pump is equal to or greater than a certain value.

15. The method of claim 11, wherein the restoring the rotation speed of the engine to the set rotation speed setting value further comprises:
deriving by the controller a discharge flow of the main pump;
deriving by the controller the torque value of the main pump using the discharge flow of the main pump and a pressure measurement value of the discharge flow of the main pump;
comparing a torque value of the main pump with a pre-stored table of maximum torque values according to the rotation speed of the engine; and
adjusting a control value of a main pump control valve connected to the main pump to a set control value so that the torque value of the main pump is reduced below a minimum torque value stored in the table for a set time.

16. The method of claim 10, wherein, before restoring the rotation speed of the engine to the set rotation speed setting value, if a driving or work signal is not input from a joystick pilot pressure sensor for a set time after the OFF signal of the auto idle function is input, the auto idle function is maintained.

17. The method of claim 10, further comprising:
before executing the auto idle function of the construction machine,
inputting an ON signal of the auto idle function during the work or driving of the construction machine; and
checking whether a work or driving signal is input from the joystick pilot pressure sensor for a set time.

18. The method of claim 10, wherein, in the restoring the rotation speed of the engine to the set rotation speed setting value, the operation of the main pump and the fan pump is not restricted after the set time.
